(19) United States
(12) Patent Application Publication
(10) Pub. No.: US 2024/0106303 A1
(43) Pub. Date: Mar. 28, 2024

(54) ELECTRIC MOTOR COOLING SYSTEM

(71) Applicant: Dana Automotive Systems Group, LLC, Maumee, OH (US)

(72) Inventors: Matthew K. PASCHALL, Medina, TN (US); Samuel Wesley COX, Paris, TN (US); Carl TRUDEL, Boucherville (CA); Alexandre PARE, Saint-Amable (CA); Steven VANHEE, Hooglede (BE); Luke MILLER, Montreal (CA); Christopher M. COOK, McKenzie, TN (US)

(21) Appl. No.: 18/472,946

(22) Filed: Sep. 22, 2023

Related U.S. Application Data
(60) Provisional application No. 63/377,159, filed on Sep. 26, 2022.

(51) Int. Cl. H02K 9/193

(52) U.S. Cl. CPC H02K 9/193

(57) ABSTRACT

Systems and methods for electric motor cooling. The cooling system, in one example, includes a sealing ring coupled to or formed in a stator and including a flange that axially extends outward from an axial side of the stator. The cooling system further includes a first sealing sleeve with a first sealing interface that is formed between the sealing sleeve and a motor housing and a second sealing interface that is formed between the sealing sleeve and the flange, where a cavity is formed between the sealing sleeve and the sealing ring in which a stator end winding is at least partially immersed in a coolant.

### CROSS-REFERENCE TO RELATED APPLICATION

The present application claims priority to U.S. Provisional Patent Application No. 63/377,159, entitled “ELECTRIC MOTOR COOLING SYSTEM”, and filed on Sep. 26, 2022. The entire contents of the above-listed application are hereby incorporated by reference for all purposes.

### TECHNICAL FIELD

The present disclosure relates to an electric motor with a cooling system that includes a sealed cavity which is formed around a stator end winding.

### BACKGROUND AND SUMMARY

In electric vehicle (EV) motor applications, stator winding cooling has been used in an attempt to achieve greater motor efficiency. For instance, efficiency targets may demand the flow of oil across the stator, in certain applications. However, in certain prior cooling system designs, oil is directed through interior cavities from which oil can leak into the air gap between the rotor and the stator. Oil in the air gap results in drag losses which results in a significant decrease in motor efficiency. The inventors have recognized that sealing the stator cooling arrangement off from other regions of the motor, such as the rotor cavity, avoids an undesirable drop in motor efficiency.

To overcome at least some of the abovementioned issues the inventors developed a motor cooling system. In one example, the motor cooling system includes a sealing ring coupled to or formed in a stator. The sealing ring includes a flange that axially extends outward from an axial side of the stator. The motor cooling system further includes a sealing sleeve and a first sealing interface that is formed between the sealing sleeve and a motor housing. The cooling system further includes a second sealing interface formed between the sealing sleeve and the flange. In the cooling system, a cavity is formed between the sealing ring and the sealing sleeve in which a stator end winding is at least partially immersed in a coolant (e.g., oil). In this way, a sealed cavity is provided that prevents fluid flow into the rotor cavity and specifically the motor's air gap. Consequently, the motor can achieve a target efficiency, if so desired.

In another example, the housing and the stator may exert an axial compressive force on the sealing ring and the sealing sleeve. In such an example, the sealing ring is coupled to the sealing sleeve without the use of fasteners and the sealing sleeve includes a shoulder that controls the axial compressive force on the sealing interface. Compressively retaining the sealing ring and the sealing lip in the motor in this manner enables the ring and the sleeve to securely form the coolant cavity with a reduced chance of coolant leakage and facilitates efficient assembly of the cooling system.

In yet another example, the sealing ring may include multiple baffles that direct the coolant towards the end windings from multiple coolant passages in the stator. In this way, the coolant may be directed through the end windings thereby increasing end winding cooling and motor efficiency, resultantly, when compared to systems that solely flow coolant around the end windings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electric motor with a cooling system.

FIG. 2 shows a cross-sectional view of the electric motor and cooling system depicted in FIG. 1.

FIGS. 3-4 show views of a first axial side of the electric motor depicted in FIG. 1.

FIGS. 5-6 show views of a second axial side of the electric motor depicted in FIG. 1.

FIGS. 7A-7C show different views of a weld-side sealing ring.

FIGS. 8A-8C show different views of a weld-side sealing sleeve.

FIGS. 9A-9C show different views of a crown-side sealing ring.

FIGS. 10A-10C show different views of a crown-side sealing sleeve.

FIG. 11 shows a cross-sectional view of the cooling system with sealed cavities in the electric motor depicted in FIG. 1.

FIG. 12 shows a detailed view of baffles in a sealing ring of the electric motor cooling system depicted in FIG. 1.

FIG. 13 shows another cross-sectional view of the cooling system in the electric motor depicted in FIG. 1.

### DETAILED DESCRIPTION

An immersion cooling system that enables an electric motor to achieve a target efficiency is described herein. The immersion cooling system includes a sealing ring and a sealing sleeve that are attached to one another via sealing interfaces to form a sealed cavity around stator end windings. The sealing ring and sleeve assemblies may be positioned on both the weld and crown sides of the stator to enable both ends of the stator to be cooled. The sealed cavities enable coolant (e.g., oil) to be directed through the stator and its end windings while preventing the coolant from entering a rotor cavity. As a result, drag losses caused by coolant in the air gap can be avoided. The sealing ring may include baffles which strategically direct coolant flow in a desired pattern within the sealed cavity. For instance, the baffles may be contoured to direct more coolant through the stator end windings rather than around the end windings. In this way, even more heat can be removed from the end windings by the cooling system. The sealing ring and sleeve may be compressively retained in a motor housing. Consequently, the sealing ring and sleeve may be efficiently and securely retained within the motor, thereby reducing the likelihood of coolant leakage from the sealed cavity.

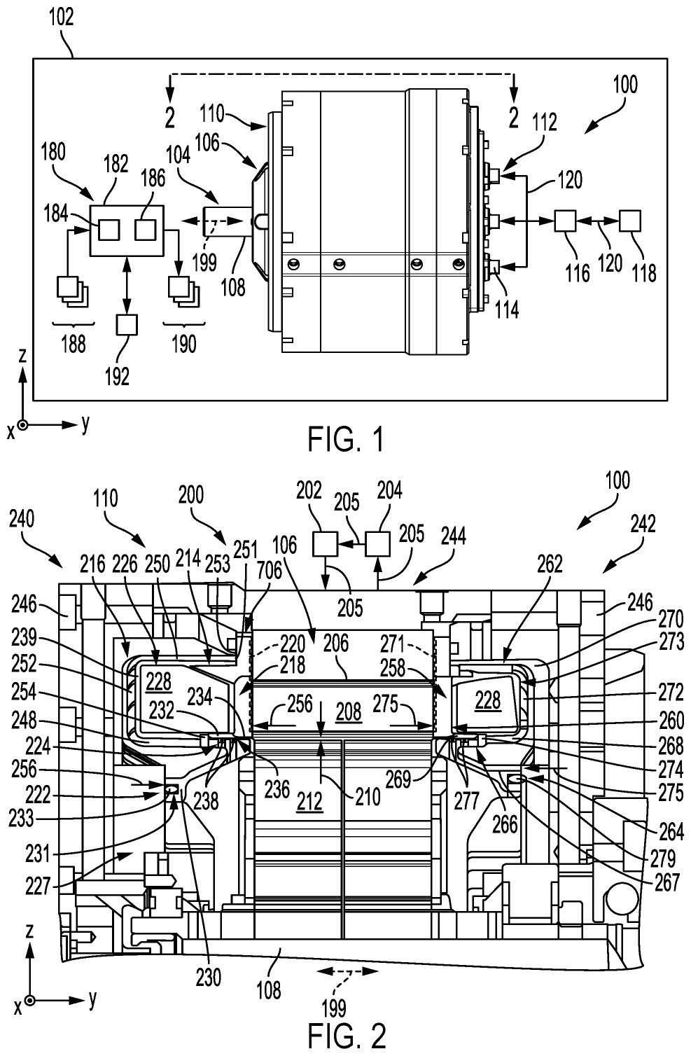

FIG. 1 shows an illustration of an electric motor 100. The electric motor 100 may be designed as an electric motor-generator and may be included in a system 102 which may take a variety forms. For instance, the electric motor 100 may be incorporated into an electric drive system of an electric vehicle (EV), in one example. As such, the electric motor is a traction motor in such an example and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. However, the motor may be used in other suitable systems (e.g., stationary systems), in other examples, such as in industrial machines, agricultural systems, mining systems, and the like.

The electric motor 100 includes a rotor 104 that electromagnetically interacts with a stator 106 to drive rotation of a rotor shaft 108 that is included in the rotor. The electric motor 100 in the illustrated example includes a housing 110 with an electrical interface 112 for the stator 106. The electrical interface 112 may be a multi-phase electrical interface with multiple electrical connectors 114. The electrical interface 112 is a three-phase interface, in the illustrated example. However, it will be understood that the electrical interface may be a six phase interface or a nine phase interface, in other examples. More generally, the electric motor 100 may be a multi-phase alternating current (AC) machine. However, in other examples, the electric motor 100 may be a direct current (DC) machine.

As illustrated in FIG. 1, the electric motor 100 may be electrically coupled to an inverter 116. The inverter 116 is designed to covert direct current (DC) power to alternating current (AC) power and vice versa. As such, the electric motor 100 may be an AC electric motor, as indicated above. However, in other examples, the electric motor 100 may be a DC electric motor (as previously indicated) and the inverter 116 may therefore be omitted from the system 102. The inverter 116 may receive electric energy from one or more energy storage device(s) 118 (e.g., traction batteries, capacitors, combinations thereof, and the like). Arrows 120 signify the electric energy transfer between the electric motor 100, the inverter 116, and the energy storage device(s) 118 that may occur during different modes of system operation.

The system 102 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like, described herein. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 positioned in different locations in the system 102. The sensors 188 may include an electric machine speed sensor, energy storage device temperature sensor(s), an energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric motor 100. In another example, the controller 182 may send a command signal to the electric motor 100 and/or the inverter 116 and in response motor speed may be adjusted. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192, responsive to user input, may generate a motor speed adjustment request.

An axis system is provided in FIG. 1, as well as FIGS. 2-13, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. Rotational axis 199 of the electric motor 100 is further provided for reference in FIG. 1 as well as FIGS. 2-10C. A cutting plane 2-2 for the cross-sectional view depicted in FIG. 2 is provided in FIG. 1. The cutting plane 2-2 extends through the motor's rotational axis.

FIG. 2 shows a cross-sectional view of the electric motor 100 and the cooling system 200 for the motor. The rotor 104 and the stator 106 of the electric motor 100 are again depicted along with the housing 110 that at least partially encloses the rotor and the stator. The rotor shaft 108 is further illustrated in FIG. 2.

The cooling system 200 may include a pump 202 and a filter 204 the deliver a coolant (e.g., oil such as a natural and/or synthetic oil) into the stator 106. Arrows 205 depict the flow of coolant between the pump 202, the filter 204, and the cooling system 200. To elaborate, the pump 202 may deliver coolant to passages 206 that axially traverse a core 208 of the stator 106, in one example. However, other coolant flow patterns may be used in other examples. The pump 202 and the filter 204 are schematically depicted. However, it will be understood that they may have greater complexity, in practice. Further, the pump and the filter are shown spaced away from the electric motor 100.

An air gap 210 is formed between a core 212 of the rotor 104 and the stator core 208. Due to the sealing of the coolant in the cooling system 200 expanded upon herein, the likelihood of coolant entering the air gap is significantly reduced (e.g., avoided).

The cooling system 200 further includes a first sealing ring 214 and a first sealing sleeve 216 are shown positioned on a first axial side 218 of the stator 106 (e.g., the stator core 208). The first axial side 218 may specifically be a weld side, in one example. The first sealing ring 214 may be coupled to or formed in the stator 106 (e.g., the stator core). Specifically, in one example, the first sealing ring 214 may be adhesively attached to the stator 106 via adhesive 220. However, in other examples, the first sealing ring may be machined or otherwise integrally formed in the stator 106.

The first sealing sleeve 216 and the first sealing ring 214 are coupled via a first sealing interface 222 and a second sealing interface 224 which form a sealed cavity 226 in which the stator end winding 228 are positioned. The sealed cavity 226 may receive and/or deliver coolant to/from the coolant passages 206 in the stator core 208. The sealed cavity 226 is specifically fluidly separated from a rotor cavity 227. In this way, coolant entering the air gap which creates drag losses in the motor can be avoided, thereby increasing motor efficiency.

The first sealing interface 222 may be formed between the housing 110 and an extension 230 of the first sealing sleeve 216 that is positioned radially inward from the end windings 228. To elaborate, the first sealing interface 222 may include a recess 231 profiled to receive a seal 233 such as an O-ring, a gasket, a diamond seal, and/or a liquid seal. The extension 230 of the first sealing sleeve 216 may taper in an axially inward direction to increase the strength of the sleeve when compared to a shoulder formed as a thinner wall.

The first sealing ring 214 includes a flange 232 that axially extends outward from the first axial side 218 of the stator 106. The flange 232 seals against an interior surface 234 of the first sealing sleeve 216 to form the second sealing interface 224. The second sealing interface 224 may specifically be formed as a radial sealing interface. Therefore, at the second sealing interface 224, the flange 232 and the interior surface 234 of the first sealing sleeve 216 to enable a strong seal to be achieved. However, other types of sealing interfaces may be used, in other examples. The interior surface 234 of the first sealing sleeve 216 may include recesses 236 sized to receive seals 238 such as O-rings, grommets, and/or a liquid seal.

The second sealing interface 224 may be positioned radially inward from the stator end winding 228 but radially outward from the first sealing interface 222, in one example. In this way, the sealed cavity 226 may be securely sealed to provide a coolant enclosure for the end windings 228. Coolant 239 circulates around the cavity and specifically through the end windings 228 to increase stator cooling when compared to systems that solely direct coolant around the end windings 228.

The housing 110 may be formed in different sections that are coupled to one another, in one example. For instance, a crown side section 240 and a weld side section 242 may be coupled to a housing body 244. The housing body 244 may circumferentially enclose the stator 106 and sealing sleeves and rings in the cooling system 200. Fasteners 246 and/or other suitable attachment devices may be used to attach the crown side section 240 and/or the weld side section 242 to the housing body 244.

The first sealing sleeve 216 may include an inner radial wall 248, an outer radial wall 250, and an axial wall 252 that allow for the sealed cavity 226 to enclose the end windings 228. However, other contours of the first sealing sleeve 216 may be used in other examples. For instance, the first sealing sleeve may include curved sections that enclose the end windings.

An end 251 of the outer radial wall 250 may be adjacent to or in face sharing contact with a surface 253 of an outer circumferential section 706. In this way, the upper section of the cavity 226 may be formed. However, other profiles of the sealing sleeve and ring may be used, in other examples.

The first sealing sleeve 216 in the second sealing interface 224 includes a shoulder 254 that allows for the axial compression of the sealing assembly to be tuned. To elaborate, the shoulder 254 hard mounts to the first sealing ring 214, when the sealing assembly is installed in the housing 110 under compression. Arrows 256 indicate the compressive force exerted on the assembly formed between the first sealing ring 214 and the first sealing sleeve 216. In this way, the first sealing ring and the sleeve may be effectively maintained in a desired position. Due to this compressive attachment of the sealing ring and sleeve in the housing the use of attachment devices for securing the ring and/or sleeve to the housing may be avoided, if desired. Consequently, manufacturing efficiency may be increased in relation to systems which utilize fasteners. A second sealing ring 260 and a second sealing sleeve 262, described in greater detail herein, may be compressed in a similar manner.

The passages 206 may extend through the stator core 208 from the first axial side 218 to a second axial side 258. In this way, coolant axially traverse the stator to enable heat to be effectively removed therefrom. The motor can consequently achieve greater efficiency, if so desired, when compared to prior motor cooling systems.

A second sealing ring 260 and a second sealing sleeve 262 are positioned on the second axial side 258 (e.g., a crown side) of the stator 106, in the illustrated example. However, in other examples, the second sealing ring and sleeve may be omitted from the motor cooling system.

Similar to the first sealing ring and sleeve, the second sealing ring 260 and the second sealing sleeve 262 may form a third sealing interface 264 and a fourth sealing interface 266. Again, the third sealing interface 264 may be a face seal formed between the housing 110 and an extension 267 and the fourth sealing interface may be a radial seal formed between a flange 269 of the second sealing ring 260. The second sealing ring 260 and the second sealing sleeve 262 may be differently sized from the first sealing ring and the first sealing sleeve to accommodate for the varied sizes of the weld and crown side end windings. However, the second sealing ring 260 and the second sealing sleeve 262 may include similar structural features to those included in the first sealing ring 214 and the first sealing sleeve 216. However, as expanded upon herein the second sealing sleeve may be contoured to accommodate for attachment between the electrical interface 112 and the stator end winding 228.

The second sealing ring 260 may be adhesively coupled to the stator core 208 via adhesive 271, in one example. However, in another example, the second sealing ring may be integrally formed with the stator core 208. Seals 277 may be included in the fourth sealing interface 266 and a seal 279 may be included in the third sealing interface 264. The seal 279 may include one or more of an O-ring, a gasket, a diamond seal, and a liquid seal. Further, the seals 277 may include one or more O-rings, grommets, and a liquid seal.

The second sealing sleeve 262 may include an inner radial wall 268, an outer radial wall 270, and an axial wall 272 that allow for a sealed cavity 273 to enclose the end windings 228. However, other contours of the second sealing sleeve 262 may be used in other examples.

The second sealing sleeve 262 again includes a shoulder 274 that has axially compressive force transmitted therethrough to enable the axial compression of the sealing assembly formed between the second sealing sleeve 262 and the second sealing ring 260 to be tuned as desired. This axial compression is represented via arrows 275.

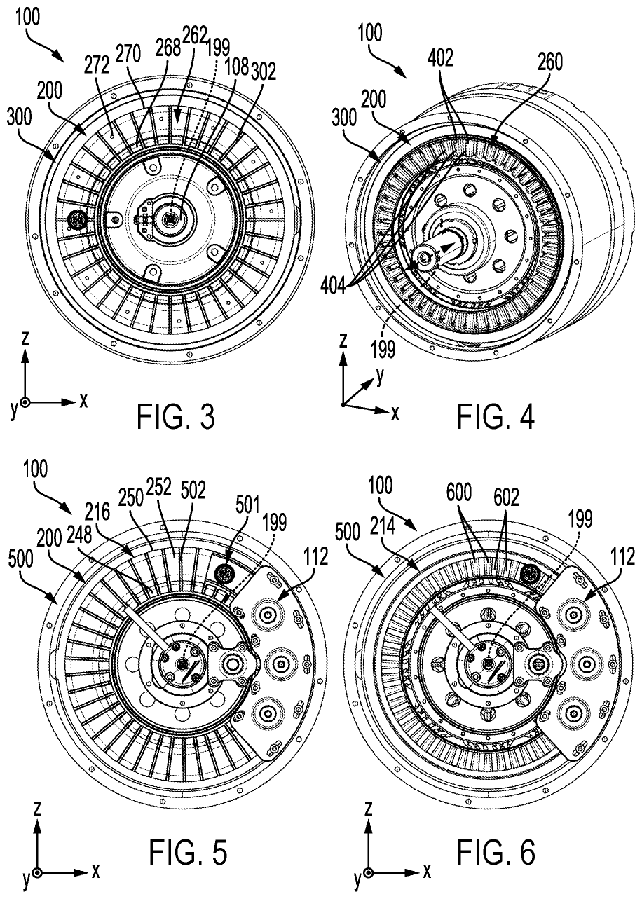

FIGS. 3-4 depict views of a crown side 300 of the electric motor 100 and associated cooling system 200. To elaborate, FIG. 3 shows a view of the electric motor 100 with the section 242 of the housing 110, depicted in FIG. 2, removed to reveal the second sealing sleeve 262. The inner radial wall 268, the outer radial wall 270, and the axial wall 272 of the second sealing sleeve 262 are again depicted. FIG. 3 further shows the rotor shaft 108. The second sealing sleeve 262 may include ribs 302 (e.g., radially aligned ribs) that extend from the outer radial wall 270 to the inner radial wall 268 to increase the structural integrity of the sleeve.

FIG. 4 shows another view of the crown side 300 of the electric motor 100 and the cooling system 200 with the second sealing sleeve 262, shown in FIG. 3, omitted to reveal the second sealing ring 260. In the illustrated example, baffles 402 with channels 404 therebetween are included in the second sealing ring 260. However, in other examples, the baffles may be omitted from the second sealing ring or formed as a separate structure. When the baffles are formed as a separate structure they may be attached to the sealing ring via mechanical and/or chemical attachment techniques such as welding (e.g., vibration welding, laser welding, and the like), single piece molding, adhesive bonding, combinations thereof, and the like.

The baffles 402 are contoured to enable the channels 404 to receive coolant from the coolant passages 206 in the stator core 208, depicted in FIG. 2, and to direct coolant towards and through the end windings 228, shown in FIG. 2. In this way, the end windings are more effectively cooled in comparison to cooling systems that solely flow coolant around the end windings. The baffles 402 are further profiled to allow the end windings to pass therethrough. To allow for the coolant flow to be directed through the end windings and to enable the end windings to pass through the second sealing ring 260, the baffles 402 may be radially aligned and/or may be symmetrically spaced at predetermined angles around the ring.

FIGS. 5-6 depict a weld side 500 of the electric motor 100 and associated cooling system 200. FIG. 5 specifically depicts the electric motor 100 with the section 240 of the housing 110, shown in FIG. 2, removed to reveal the first sealing sleeve 216. The first sealing sleeve 216 includes an opening 501 to enable the electrical interface 112 for the stator to pass therethrough and electrically attach to the stator end windings. In this way, the first sealing sleeve may be efficiently incorporated into the motor. The first sealing sleeve 216 may include ribs 502 which extend along the inner radial wall 248 and the axial wall 252.

FIG. 6 shows the weld side 500 of the electric motor with the first sealing sleeve 216, shown in FIG. 5, removed to reveal the first sealing ring 214. The first sealing ring 214 includes baffles 600 and channels 602 which may share structural and functional overlap with the baffles 402 and the channels 404, shown in FIG. 4. Redundant description is therefore omitted for brevity.

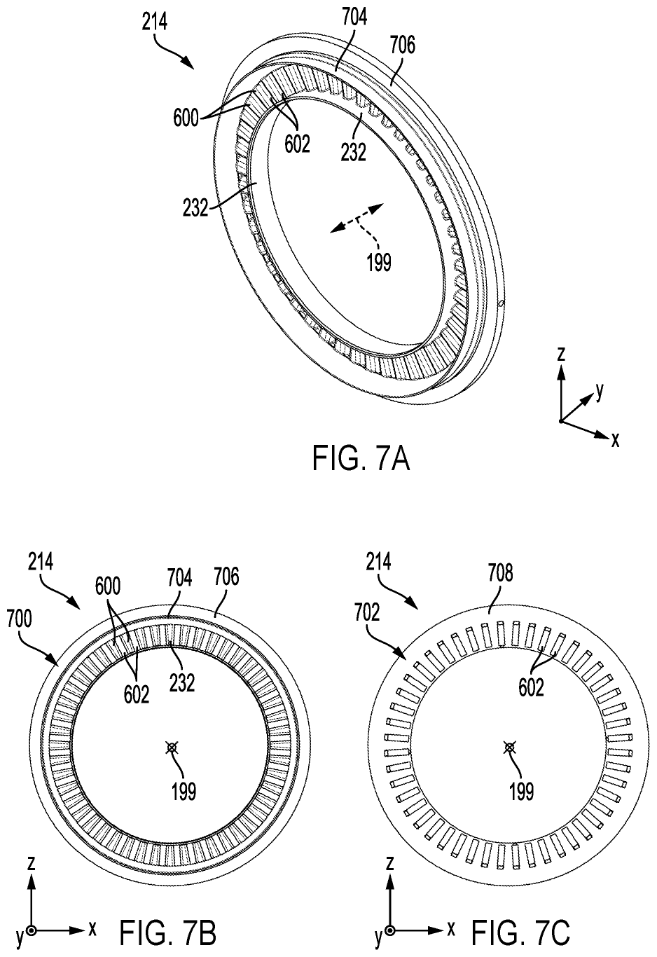

FIGS. 7A-7C depict different views of the first sealing ring 214. FIG. 7A specifically shows the flange 232 of the first sealing ring 214 along with the baffles 600 and channels 602.

FIG. 7B shows an outboard axial side 700 of the first sealing ring 214 and FIG. 7C shows an inboard axial side 702 of the first sealing ring 214. The channels 602 between the baffles 600 extend in radial directions and are aligned with the stator such that coolant can pass through the channels 602 and be direct towards the end windings. The channels 602 may have a rectangular cross-sectional contour, in one example. However, other channel profiles have been contemplated. An outer flange 704 that extends from an outer circumferential section 706 of the first sealing ring 214 is further depicted in FIG. 7A. When the first sealing ring 214 is attached to the first sealing sleeve 216, depicted in FIG. 2, the outer radial wall 250 of the first sealing sleeve 216, depicted in FIG. 2, may be adjacent to or in contact with the section 706 and thus may overlap the outer flange 704.

Further, as shown in FIG. 7C a surface 708 of the first sealing ring 214 may be substantially planar to allow for the first sealing ring to be adhesively attached (e.g., bonded) to the stator core, in one example. However, in other examples the surface of the ring that is adhesively attached to the stator may be partially curved, textured, etc.

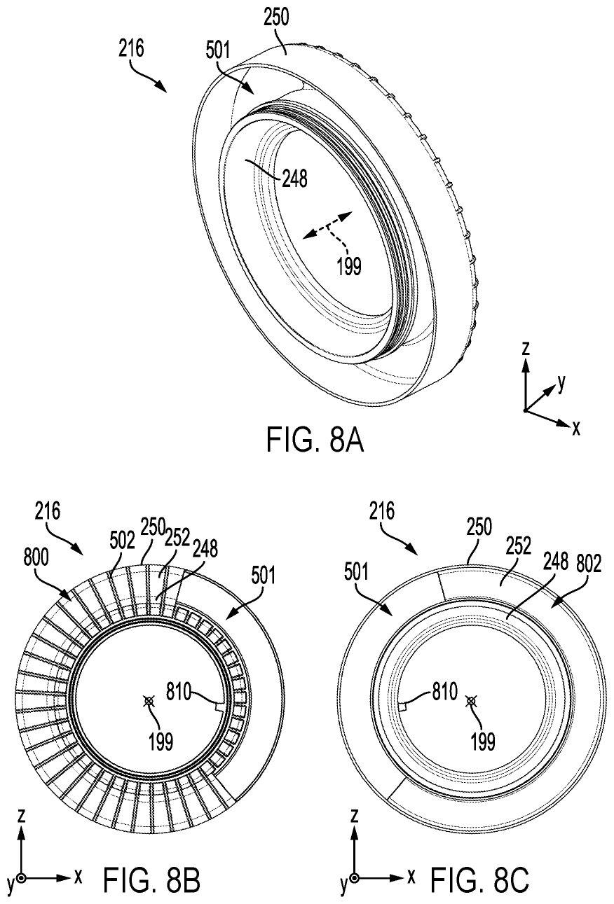

FIGS. 8A-8C depict different views of the first sealing sleeve 216. The inner radial wall 248, the outer radial wall 250, and the axial wall 252 of the first sealing sleeve 216 are again shown along with the opening 501 that allows the electrical interface 112, shown in FIGS. 5-6, to connect to the stator end windings.

FIG. 8B depicts an outboard side 800 of the first sealing sleeve 216 and FIG. 8C depicts an inboard side 802 of the sleeve. The ribs 502 are additionally illustrated in FIG. 8B. To form the opening 501, a portion of the axial wall 252 is cut-out to enable the electrical interface to extend therethrough.

FIGS. 8B-8C depict an indexing mechanism 810 that may extend inwardly toward the motor's rotational axis to enable the first sealing sleeve 216 to be properly aligned with the electrical interface 112, shown in FIGS. 5-6, to connect to the stator end windings. The motor's manufacturing efficiency may be increased as a result. In the illustrated example, the indexing mechanism 810 is positioned inward from the opening. However, the indexing mechanism may be positioned in an alternate location, in other embodiments. Further, the inner radial wall 248 may have a conical shape to increase the strength of the sleeve. Thus, the inner radial wall may be referred to as a conical section.

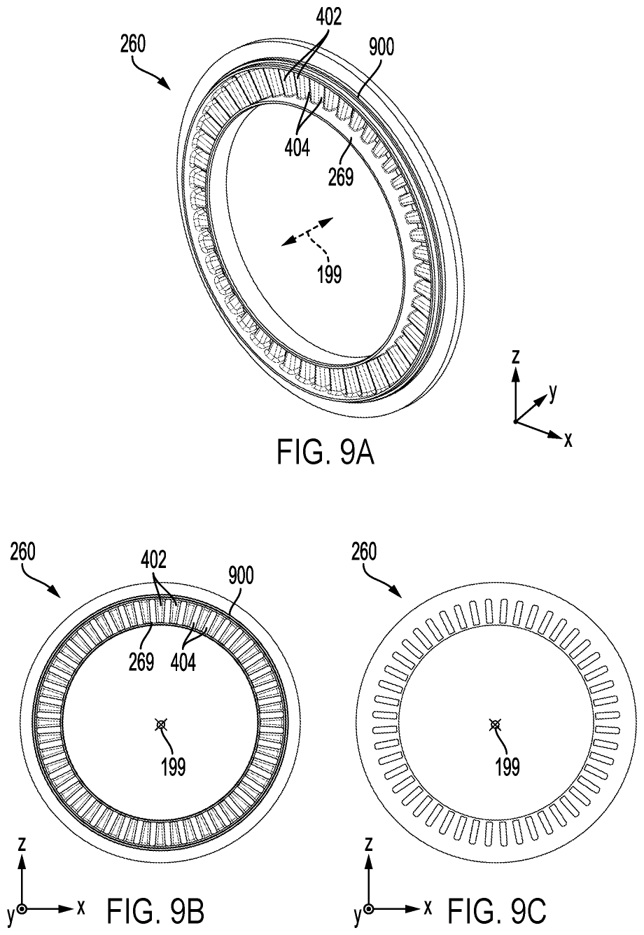

FIGS. 9A-9C depict different views of the second sealing ring 260. FIG. 9A specifically shows the flange 269 of the second sealing ring 260 along with the baffles 402 and channels 404. As previously indicated, the second sealing ring may include structural features that are similar to the first sealing ring and repeated description of the overlapping features is omitted for concision.

The second sealing ring 260 includes an outer flange 900 which may be smaller than the outer flange 232 of the first sealing ring 214, shown in FIG. 7A, to accommodate for the different profiles of the end windings at the crown and weld sides of the stator.

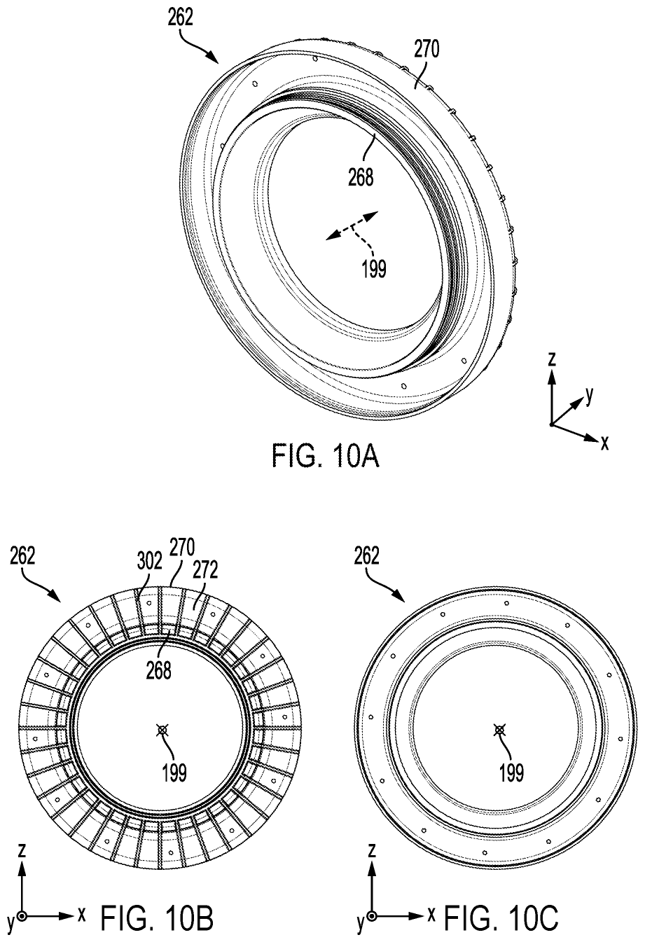

FIGS. 10A-10C depict different views of the second sealing sleeve 262. The inner radial wall 268, the outer radial wall 270, and the axial wall 272 of the second sealing sleeve 262 are again shown. Ribs 302 in the second sealing sleeve 262 are shown in FIG. 10B which provide increased structural integrity to the sleeve, as indicated above.

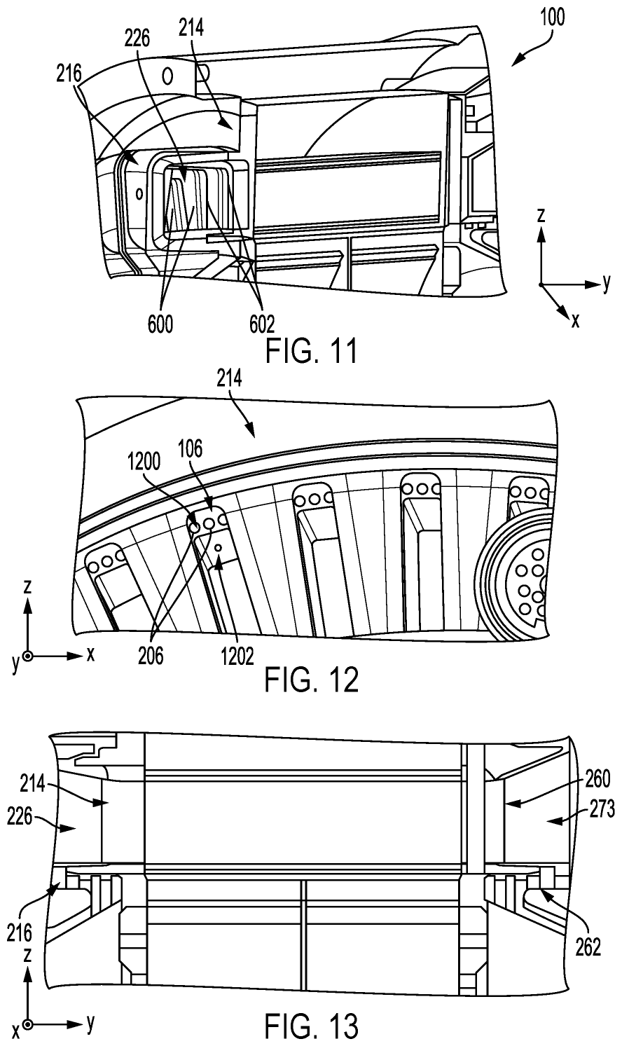

FIG. 11 shows a cross-sectional view of the electric motor 100 which reveals the sealed cavity 226 where the end windings have been omitted. The first sealing sleeve 216, the first sealing ring 214, the baffles 600, and the channels 602 are again depicted.

FIG. 12 shows a detailed view of the coolant passages 206 that extend through the stator 106. The coolant passages 206 include openings 1200 which are aligned with the channels 602 between the baffles 600 in the first sealing ring 214. In this way, coolant is effectively flowed into the sealed cavity. The stator 106 may further include openings 1202 that is sized and profiled to allow the end windings to pass therethrough.

FIG. 13 shows another cross-sectional view of the electric motor 100 where the radial sealing interfaces between the sealing rings 214, 260 and sealing sleeves 216, 262 are again illustrated, that form the sealed cavities 226, 273.

FIGS. 1-13 provide for a method used to operate an electric motor cooling system. The method may be implemented by the electric motor cooling system shown in FIGS. 1-13 or other suitable motor cooling systems. The actions in the method may be implemented by instructions stored in memory of a controller that are executable by a processor. The method includes flowing coolant from multiple coolant passages that extend through the stator into a sealed cavity that is formed between a sealing ring and a sealing sleeve and encloses a stator end winding. The method may further include circulating the coolant through the stator core. In this way, the stator may be strategically cooled while avoiding coolant flow into the rotor cavity.

The technical effect of the motor cooling system operating method is to effectively cool the stator end windings using a sealed cavity that reduced the chance of (e.g., avoids) coolant leakage into the rotor cavity, thereby increasing motor efficiency in relation to prior motor cooling systems.

FIGS. 1-13 are drawn approximately to scale, aside from the schematically depicted components. However, the components may have other relative dimensions, in other embodiments.

FIGS. 1-13 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

The invention will be further described in the following paragraphs. In one aspect, an electric motor cooling system is provided that comprises a first sealing ring coupled to or formed in a stator and including a flange that axially extends outward from a first axial side of the stator; and a first sealing sleeve including: a first sealing interface that is formed between the first sealing sleeve and a motor housing; and a second sealing interface that is formed between the first sealing sleeve and the flange; wherein a cavity is formed between the first sealing ring and the first sealing sleeve in which a stator end winding is at least partially immersed in a coolant.

In another aspect, a method for cooling an electric motor is provided that comprises flowing a coolant from a plurality of coolant passages that extend through the stator into a sealed cavity that is formed between a sealing ring and a sealing sleeve and encloses end windings of a stator; wherein the sealing ring is coupled to or formed in the stator and includes a flange that axially extends outward from a first axial side of the stator; wherein the sealing sleeve includes a first sealing interface formed between the sealing sleeve and a motor housing and a second sealing interface formed between the sealing sleeve and the flange; and wherein a cavity is formed between the first sealing ring and the first sealing sleeve in which a stator end winding is at least partially immersed in a coolant.

In yet another aspect, an immersion cooling system for an electric motor is provided that comprises a sealing ring coupled to a stator and including a flange that axially extends outward from an axial side of the stator; a sealing sleeve including: a face seal formed between the sealing sleeve and a motor housing; and a radial seal formed between the sealing sleeve and the flange; and a cavity formed between the sealing ring and the sealing sleeve in which a stator end winding is at least partially immersed in oil; wherein the sealing ring and the sealing sleeve are axially compressed between the axial side of the stator and an interior surface of the housing.

In any of the aspects or combinations of the aspects, the housing and the stator may exert an axial compressive force on the first sealing ring and the first sealing sleeve.

In any of the aspects or combinations of the aspects, the first sealing ring may be coupled to the first sealing sleeve without the use of fasteners.

In any of the aspects or combinations of the aspects, the first sealing sleeve may include a shoulder that controls the axial compressive force on the first sealing interface.

In any of the aspects or combinations of the aspects, the first sealing ring may include a plurality of baffles that direct the coolant towards the end windings from a plurality of coolant passages in the stator.

In any of the aspects or combinations of the aspects, the sealing ring may be adhesively attached to the stator on an axial end face.

In any of the aspects or combinations of the aspects, the first sealing ring may include a conical section.

In any of the aspects or combinations of the aspects, the second sealing interface may be a radial sealing interface.

In any of the aspects or combinations of the aspects, the radial sealing interface may include one or more of an O-ring, a grommet, and a liquid seal.

In any of the aspects or combinations of the aspects, the first sealing interface may form a face seal.

In any of the aspects or combinations of the aspects, the face seal may include one or more of an O-ring, a gasket, a diamond seal, and a liquid seal.

In any of the aspects or combinations of the aspects, the electric motor cooling system may further include an indexing device aligned with an opening in the first sealing sleeve.

In any of the aspects or combinations of the aspects, the electric motor cooling system may further include a second sealing ring coupled to or formed in a stator and including a flange that axially extends outward from a second axial side of the stator; and a second sealing sleeve with a third sealing interface formed between the second sealing sleeve and a motor housing and a fourth sealing interface formed between the second sealing sleeve and the flange; wherein the first and second sealing rings and sleeves have different profiles.

In any of the aspects or combinations of the aspects, the first sealing ring and the first sealing sleeve may be positioned on a crown side of the stator and the second sealing ring and the second sealing sleeve may be positioned on a weld side of the stator.

In any of the aspects or combinations of the aspects, the electric motor cooling system may be included in an electric drive system in a vehicle.

In any of the aspects or combinations of the aspects, the coolant may be oil.

In any of the aspects or combinations of the aspects, the sealed cavity may be positioned radially outward from a rotor cavity and fluidly isolated therefrom.

In any of the aspects or combinations of the aspects, the sealed cavity may be positioned radially outward from a rotor cavity and fluidly isolated therefrom.

In any of the aspects or combinations of the aspects, the sealing ring may be adhesively attached to an axial end face of the stator and includes a plurality of baffles that direct the oil towards the stator end winding from a plurality of coolant passages in the stator.

In another representation, an immersion cooling system for an electric machine is provided that includes a sealed stator end winding enclosure that is fluidly separated from a rotor cavity and is formed between multiple sealed interfaces that are formed between a ring and a sleeve, where the ring is coupled to or incorporated in a stator core and the ring and sleeve are compressively held within an electric machine housing.

Note that the example control and estimation routines included herein can be used with various motor configurations. The control methods and routines disclosed herein may be stored as executable instructions in non-transitory memory and may be carried out by the control system including the controller in combination with the various sensors, actuators, and other electric drive and/or vehicle hardware in combination with the electronic controller. As such, the described actions, operations, and/or functions may graphically represent code to be programmed into non-transitory memory of the computer readable storage medium in the vehicle and/or driveline control system. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric motor cooling system, comprising:
a first sealing ring coupled to or formed in a stator and including a flange that axially extends outward from a first axial side of the stator; and
a first sealing sleeve including:
a first sealing interface that is formed between the first sealing sleeve and a motor housing; and
a second sealing interface that is formed between the first sealing sleeve and the flange;
wherein a cavity is formed between the first sealing sleeve and the first sealing ring in which a stator end winding is at least partially immersed in a coolant.

2. The electric motor cooling system of claim 1, wherein the motor housing and the stator exert an axial compressive force on the first sealing ring and the first sealing sleeve.

3. The electric motor cooling system of claim 2, wherein the first sealing ring is coupled to the first sealing sleeve without using fasteners.

4. The electric motor cooling system of claim 2, wherein the first sealing sleeve includes a shoulder that controls the axial compressive force on the first sealing interface.

5. The electric motor cooling system of claim 1, wherein the first sealing ring includes a plurality of baffles that direct the coolant towards the stator end winding from a plurality of coolant passages in the stator.

6. The electric motor cooling system of claim 1, wherein the first sealing ring is adhesively attached to the stator on an axial end face.

7. The electric motor cooling system of claim 1, wherein the first sealing ring includes a conical section.

8. The electric motor cooling system of claim 1, wherein the second sealing interface is a radial sealing interface.

9. The electric motor cooling system of claim 8, wherein the radial sealing interface includes one or more of an O-ring, a grommet, and a liquid seal.

10. The electric motor cooling system of claim 1, wherein the first sealing interface forms a face seal.

11. The electric motor cooling system of claim 10, wherein the face seal includes one or more of an O-ring, a gasket, a diamond seal, and a liquid seal.

12. The electric motor cooling system of claim 1, further comprising an indexing device aligned with an opening in the first sealing sleeve.

13. The electric motor cooling system of claim 1, further comprising:
a second sealing ring coupled to or formed in the stator and including a second flange that axially extends outward from a second axial side of the stator; and
a second sealing sleeve with a third sealing interface formed between the second sealing sleeve and the motor housing and a fourth sealing interface formed between the second sealing sleeve and the second flange;
wherein the first and second sealing rings and sleeves have different profiles.

14. The electric motor cooling system of claim 13, wherein the first sealing ring and the first sealing sleeve are positioned on a crown side of the stator and the second sealing ring and the second sealing sleeve are positioned on a weld side of the stator.

15. The electric motor cooling system of claim 1, wherein the electric motor cooling system is included in an electric drive system in a vehicle.

16. The electric motor cooling system of claim 1, wherein the coolant is oil.

17. A method for cooling an electric motor, comprising:
flowing a coolant from a plurality of coolant passages that extend through a stator into a sealed cavity that is formed between a sealing ring and a sealing sleeve and encloses end windings of the stator;
wherein the sealing ring is coupled to or formed in the stator and includes a flange that axially extends outward from an axial side of the stator;
wherein the sealing sleeve includes a first sealing interface formed between the sealing sleeve and a motor housing and a second sealing interface formed between the sealing sleeve and the flange; and
wherein a cavity is formed between the sealing ring and the sealing sleeve in which the stator end winding is at least partially immersed in a coolant.

18. The method of claim 17, wherein the sealed cavity is positioned radially outward from a rotor cavity and fluidly isolated therefrom.

19. An immersion cooling system for an electric motor, comprising:
a sealing ring coupled to a stator and including a flange that axially extends outward from an axial side of the stator;
a sealing sleeve including:
a face seal formed between the sealing sleeve and a motor housing; and
a radial seal formed between the sealing sleeve and the flange; and
a cavity formed between the sealing ring and the sealing sleeve in which a stator end winding is at least partially immersed in oil;
wherein the sealing ring and the sealing sleeve are axially compressed between the axial side of the stator and an interior surface of the motor housing.

20. The immersion cooling system of claim 19, wherein the sealing ring is adhesively attached to an axial end face of the stator and includes a plurality of baffles that direct the oil towards the stator end winding from a plurality of coolant passages in the stator.
